(19) United States
(12) Patent Application Publication
(10) Pub. No.: US 2014/0368300 A1
(43) Pub. Date: Dec. 18, 2014

(54) Waveguide Filter, Preparation Method Thereof and Communication Device

(71) Applicant: Huawei Technologies, Co., Ltd., Shenzhen (CN)

(72) Inventors: Yanzhao Zhou, Milano (IT); Yufeng Dai, Shenzhen (CN); Xiang Wei, Kista (SE)

(21) Appl. No.: 14/451,661

(22) Filed: Aug. 5, 2014

Related U.S. Application Data
(63) Continuation of application No. PCT/CN2013/084266, filed on Sep. 26, 2013.

(30) Foreign Application Priority Data
May 24, 2013 (CN) 201310198393.7

(51) Int. Cl. H01P 1/207; H01P 11/00

(52) U.S. Cl. CPC H01P 1/207; H01P 11/007
USPC 333/208; 29/600

(57) ABSTRACT

A waveguide filter, a preparation method thereof, and a communication device to resolve a problem in which a prepared high-resonance-frequency waveguide filter cannot meet an application requirement due to a low precision of an existing machining process. The waveguide filter includes a substrate made of a silicon material, where an etching cavity having a flat side wall is formed in the substrate, a depth of the etching cavity is not greater than 0.7 mm, and an angle between the side wall of the etching cavity and a vertical direction is not smaller than 1 degree, and a waveguide port is disposed on the substrate, where the waveguide port is connected to the etching cavity and electrically connected to the etching cavity.

### CROSS-REFERENCE TO RELATED APPLICATIONS

This application is a continuation of International Application No. PCT/CN2013/084266, filed on Sep. 26, 2013, which claims priority to Chinese Patent Application No. 201310198393.7, filed on May 24, 2013, both of which are hereby incorporated by reference in their entireties.

### TECHNICAL FIELD

The present invention relates to a component of a communication device, and in particular, to a waveguide filter, a preparation method thereof, and a communication device.

### BACKGROUND

A waveguide filter has characteristics of low insertion loss, large power capacity, and ease of mass production, and has an operating frequency up to a millimeter wave band. Therefore, it is widely used in microwave communication devices.

A waveguide filter is mainly formed by a metallic cavity and a tuning screw, where the metallic cavity consists of at least three resonant cavities, and the tuning screw is disposed on a wall of the metallic cavity, where a resonance frequency of the waveguide filter may be adjusted by adjusting a penetration depth of the tuning screw into the metallic cavity. A rectangular waveguide port is further disposed on the wall of the metallic cavity, where the waveguide port is connected to the resonant cavity and is used as an input or output port for a signal.

An existing process of preparing a waveguide filter is mainly a machining process. This type of machining process normally has a precision ranging from 0.02 millimeter (mm) to 0.05 mm. As a microwave frequency increases, a wavelength of an electromagnetic wave linearly decreases. Therefore, a minor error in a physical size may result in a large deviation of an electromagnetic resonance frequency, causing a dimensional precision required for mass-producing a 70-80 Gigahertz (GHz) filter to be smaller than 20 micrometer (μm). Apparently, a high-resonance-frequency waveguide filter prepared by using the existing machining process may not meet an application requirement.

### SUMMARY

Embodiments of the present invention provide a waveguide filter, a preparation method thereof, and a communication device, that may enable a high resonance frequency waveguide filter to meet an application requirement.

To achieve the foregoing objective, the embodiments of the present invention adopt the following technical solutions.

According to a first aspect, an embodiment of the present invention provides a waveguide filter, including a substrate made of a silicon material, where an etching cavity having a flat side wall is formed in the substrate, a depth of the etching cavity is not greater than 0.7 mm, and an angle between the side wall of the etching cavity and a vertical direction is not smaller than 1 degree, and a waveguide port is disposed on the substrate, where the waveguide port is connected to the etching cavity and electrically connected to the etching cavity.

According to a second aspect, an embodiment of the present invention provides a method for preparing a waveguide filter, including providing a substrate made of a silicon material, and forming, by using a micro-electro-mechanical systems (MEMS) machining process, an etching cavity in the substrate, and forming, on the substrate, a waveguide port that is connected to the etching cavity and electrically connected to the etching cavity.

According to a third aspect, an embodiment of the present invention provides a communication device, including a printed circuit board, where the foregoing waveguide filter is mounted on the printed circuit board.

In the waveguide filter, the preparation method thereof, and the communication device provided by the embodiments of the present invention, an etching cavity having a flat side wall is formed in a substrate made of a silicon material, where a depth of the etching cavity may be not greater than 0.7 mm and the side wall of the cavity formed by etching has a tilt angle no smaller than 1 degree. Because etching is one of the core technologies of a MEMS machining process and has a machining precision of 1 μm, the etching cavity, which is used as a resonant cavity of the waveguide filter, has a small size and a high precision. Compared with a waveguide filter formed by using an existing machining process, the size is reduced by 50 times, and the precision is improved by 20 times, so that an obtained performance parameter can meet an application requirement and debugging may not be required, thereby significantly reducing a cost for manufacturing a high-resonance-frequency waveguide filter.

### BRIEF DESCRIPTION OF DRAWINGS

To describe the technical solutions in the embodiments of the present invention more clearly, the following briefly introduces the accompanying drawings required for describing the embodiments.

FIG. 1 is a sectional view of a waveguide filter according to an embodiment of the present invention;

FIG. 2 is a top view of an upper portion of a waveguide filter that is illustrated in FIG. 1 and cut along line A-A;

FIG. 3 is a bottom view of a lower portion of a waveguide filter that is illustrated in FIG. 1 and cut along line A-A;

FIG. 4 is an exploded sectional view of another waveguide filter according to an embodiment of the present invention;

FIG. 5 is an exploded sectional view of yet another waveguide filter according to an embodiment of the present invention;

FIG. 6 is a flowchart of a method for preparing a waveguide filter according to an embodiment of the present invention;

FIG. 7 is a flowchart of a method for preparing another waveguide filter according to an embodiment of the present invention;

FIG. 8 is a flowchart of a method for preparing another waveguide filter according to an embodiment of the present invention; and

FIG. 9 is a sectional view of a communication device according to an embodiment of the present invention.

### DESCRIPTION OF EMBODIMENTS

The following clearly describes the technical solutions in the embodiments of the present invention with reference to the accompanying drawings in the embodiments of the present invention.

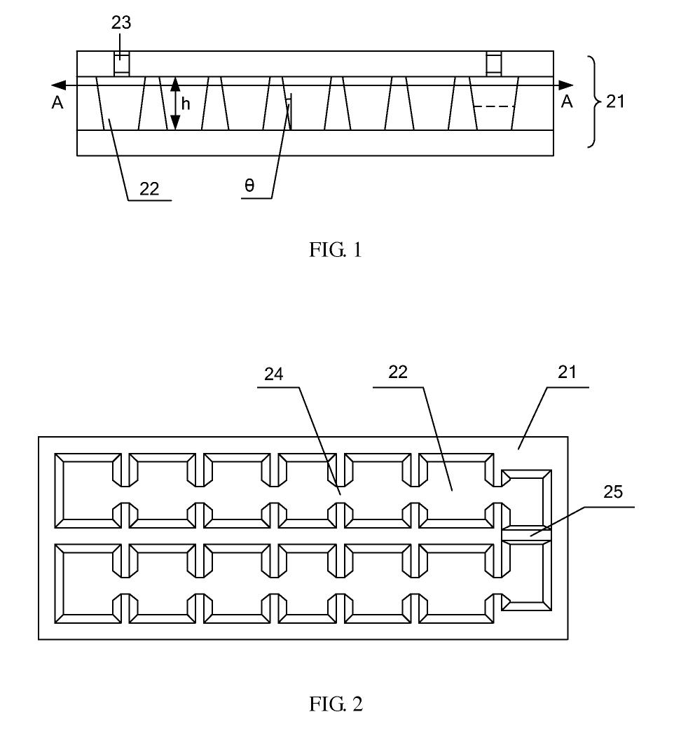

An embodiment of the present invention provides a waveguide filter, which, as shown in FIG. 1 to FIG. 3, includes a substrate 21 made of a silicon material, where an etching cavity 22 having a flat side wall is formed in the substrate 21, a depth h of the etching cavity 22 is not greater than 0.7 mm, and an angle θ between the side wall of the etched cavity 22 and a vertical direction is not smaller than 1 degree, and a waveguide port 23 is disposed on the substrate 21, where the waveguide port 23 is connected to the etching cavity and electrically connected to the etching cavity 22.

In the waveguide filter provided by this embodiment of the present invention, an etching cavity having a flat side wall is formed in a substrate made of a silicon material, where a depth of the etching cavity may be not greater than 0.7 mm and the side wall of the cavity formed by etching has a tilt angle no smaller than 1 degree. Because etching is one of the core technologies of a MEMS machining process and has a machining precision of 1 μm, the etching cavity, which is used as a resonant cavity of the waveguide filter, has a small size and a high precision. Compared with a waveguide filter formed by using an existing machining process, the size is reduced by 50 times, and the precision is improved by 20 times, so that an obtained performance parameter can meet an application requirement and debugging may not be required, thereby significantly reducing a cost for manufacturing a high-resonance-frequency waveguide filter.

Specifically, the MEMS refers to a micro device or system that can be mass-produced and that integrates a micro mechanism, a micro sensor, a micro actuator, a signal processing and control circuit, an interface, a power supply, and the like. The MEMS machining process is derived on a basis of a semiconductor integrated circuit microfabrication technology and an ultraprecision machining technology, where a machining precision of the MEMS machining process is up to 1 μm.

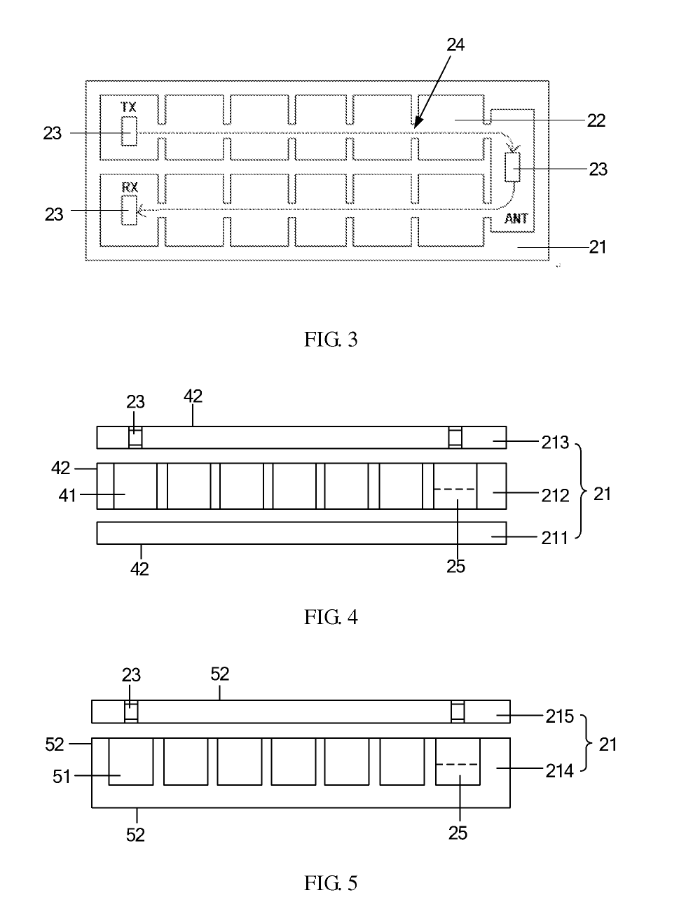

A waveguide filter illustrated in FIG. 3 is a specific implementation manner of the present invention, where three waveguide ports 23 are disposed. Among two adjacent waveguide ports 23 on the left, the waveguide port 23 indicated by TX is used as a signal transmitting end, and the waveguide port 23 indicated by RX is used as a signal receiving end. The waveguide port 23 indicated by ANT on the right is used as an antenna end. The waveguide filter is used as a duplexer in a communication circuit. A direction indicated by the dashed arrow in FIG. 3 is a direction in which a signal is transmitted.

Certainly, the present invention is not limited thereto. There may be two waveguide ports so that the waveguide filter has only a function of unidirectional wave filtering, and there may also be multiple waveguide ports so that the waveguide filter can be used as a multiplexer or a combiner.

Three waveguide ports 23 are disposed in the waveguide filter illustrated in FIG. 3. In order to ensure that input impedance of the waveguide filter matches output impedance to protect a high-frequency signal from being reflected inside the substrate 21, in FIG. 2, a matching section 25 is disposed in the substrate 21 and adjacent to the antenna end, where the matching section 25 is a protrusion located in the substrate 21 and may be rectangular, triangular, or in another irregular shape, and a size is also not limited to that illustrated in FIG. 2 as long as a function of impedance matching is performed.

It should be noted that a cross section of the etching cavity 22 in FIG. 1 is in a trapezoid shape and is horizontally arranged on a horizontal plane. A person skilled in the art should know that, the present invention is not limited thereto, and a cross section of a resonant cavity may also be in a triangle shape or another shape obtained by etching, and the resonant cavity may be arranged in three dimensions both on a horizontal surface and in a direction perpendicular to the horizontal surface.

Adjacent resonant cavities are coupled by using a coupling window 24. A size of the coupling window is also an important parameter that determines performance of the waveguide filter, and may be designed according to a requirement.

In the waveguide filter illustrated in FIG. 1, the substrate 21 may include, as shown in FIG. 4, a bottom plate 211, a first base plate 212, and a first cover plate 213. An etching through hole 41 is disposed in the first base plate 212, a waveguide port 23 is disposed on the first cover plate 213, and a surface of the bottom plate 211, the first base plate 212, and the first cover plate 213 is plated with a conducting layer 42, and an etching cavity that is connected to the waveguide port 23 and electrically connected to the waveguide port 23 is formed when the bottom plate 211 and the first cover plate 213 are separately placed over two ends of the etching through hole 41 and are bonded to the first base plate 212.

In this implementation manner, a substrate 21 having a three-layer structure is used. The etching through hole 41 formed in the first base plate 212 of the substrate 21 is eventually used as the etching cavity, and therefore a depth of the etching cavity may be determined merely by selecting a first base plate 212 having a proper thickness, which allows a depth of the formed etching cavity to be relatively easily controlled.

The first base plate may be a single-layer silicon wafer or a multi-layer stack of silicon wafers, where adjacent silicon wafers among the multiple-layer stack of silicon wafers are bonded together to ensure consistent electrical conductivity between the wafers. The silicon wafer to be used may be a low-resistivity silicon wafer, a high-resistivity silicon wafer, or a relatively-low-purity silicon wafer which have a diameter greater than 2 inches and a thickness ranging from 100 μm to 2 mm. Because a relatively-low-purity silicon wafer has a low price, use of a relatively-low-purity silicon wafer may reduce a cost for preparing a waveguide filter.

In the waveguide filter illustrated in FIG. 1, the substrate 21 may include, as shown in FIG. 5, a second base plate 214 and a second cover plate 215. An etching groove 51 is disposed on the second base plate 214, a waveguide port 23 is disposed on the second cover plate 215, a surface of the second base plate 214 and the second cover plate 215 is plated with a conducting layer 52, and an etching cavity that is connected to the waveguide port 23 and electrically connected to the waveguide port 23 is formed when the second cover plate 215 is placed over an opening side of the etching groove 51 and is bonded to the second base plate.

In this implementation manner, a substrate 21 having a two-layer structure is used, which may reduce steps for preparing a waveguide filter, and thereby reduce a cost.

The second base plate 214 may be a single-layer silicon wafer or a multi-layer stack of silicon wafers, where adjacent silicon wafers among the multiple-layer stack of silicon wafers are bonded together to ensure consistent electrical conductivity between the wafers. The silicon wafer to be used may be a low-resistivity silicon wafer, a high-resistivity silicon wafer, or a relatively-low-purity silicon wafer which has a diameter greater than 2 inches and a thickness ranging from 100 μm to 2 mm. Because a relatively-low-purity silicon wafer has a low price, use of a relatively-low-purity silicon wafer may reduce a cost for preparing a waveguide filter.

It should be noted that all the waveguide ports of the waveguide filters illustrated in FIG. 1, FIG. 4, and FIG. 5 are disposed on a cover plate; however, the present invention is not limited thereto, and a waveguide port may be designed to be at another position according to an actual need, for example, on a side wall of a base plate.

In the waveguide filters provided by the foregoing embodiments, a material of the conducting layer may be a combination of one or more of the following gold, silver, copper, aluminum, palladium, nickel, titanium, and chromium. The conducting layer may also be a stack of multiple metallic layers. For example, the conducting layer is a stack of two metallic layers, where a first layer is an aluminum layer and a second layer is a silver layer. The stacking of multiple metallic layers can improve electrical conductivity performance of a surface of the waveguide filters.

Moreover, an insulation layer may be disposed between adjacent metallic layers among the multiple metallic layers. For example, an insulation layer is disposed between an aluminum layer and a silver layer that are stacked together, where such an arrangement may reduce a skin effect of the waveguide filters.

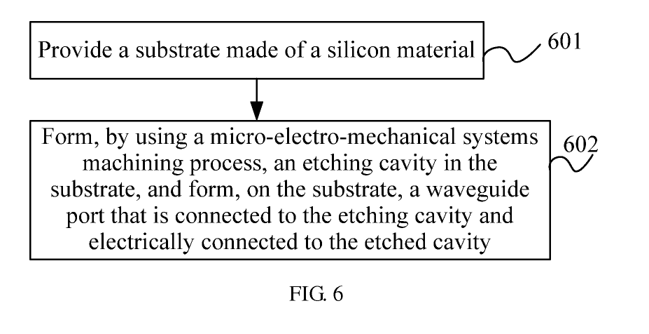

An embodiment of the present invention further provides a method for preparing a waveguide filter. As shown in FIG. 6 and FIG. 1 to FIG. 3, the method includes the following steps.

601. Provide a substrate 21 made of a silicon material.

602. Form, by using a MEMS machining process, an etching cavity 22 in the substrate 21, and form, on the substrate 21, a waveguide port 23 that is connected to the etching cavity 22 and electrically connected to the etching cavity 22.

Specifically, the MEMS refers to a micro device or system that can be mass-produced and that integrates a micro mechanism, a micro sensor, a micro actuator, a signal processing and control circuit, an interface, communication, a power supply, and the like. The MEMS machining process is derived on a basis of a semiconductor integrated circuit microfabrication technology and an ultraprecision machining technology, where a machining precision of the MEMS machining process is up to 1 μm.

In the method for preparing a waveguide filter according to the embodiment of the present invention, because the MEMS machining process with a high machining precision is used, precision is improved by 20 times when compared with an existing machining process. Therefore, the prepared high-resonance-frequency waveguide filter can meet an application requirement; moreover, because a precision for preparing the waveguide filter is high, and debugging may not be required, thereby significantly reducing a cost for preparing the high-resonance-frequency waveguide filter.

It should be noted that a cross section of the etching cavity 22 in FIG. 1 to FIG. 3 is in a trapezoid shape and is horizontally arranged on a horizontal plane. A person skilled in the art should know that, the present invention is not limited thereto, and a cross section of the etching cavity may also be in a triangle shape or another irregular shape, and the etching cavity may be arranged in three dimensions both on a horizontal surface and in a direction perpendicular to the horizontal surface. Any shape and an arrangement of the etching cavity may be applicable to the present invention as long as the etching cavity can be prepared and obtained by using the MEMS machining process and a performance indicator requirement of the waveguide filter can be met.

To further describe the foregoing method for preparing a waveguide filter, an embodiment of the present invention further provides two methods for preparing a waveguide filter. The following separately describes the two preparation methods with reference to the accompanying drawings.

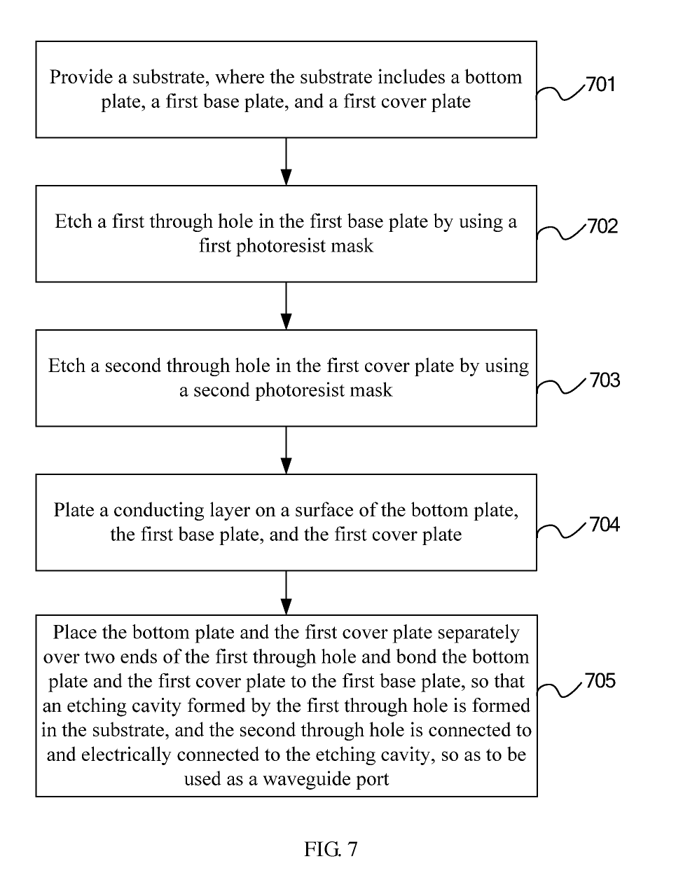

As shown in FIG. 4 and FIG. 7, a method for preparing a waveguide filter includes the following steps.

701. Provide a substrate 21, where the substrate 21 includes a bottom plate 211, a first base plate 212, and a first cover plate 213.

702. Etch a first through hole 41 in the first base plate 212 by using a first photoresist mask.

703. Etch a second through hole in the first cover plate 213 by using a second photoresist mask.

704. Plate a conducting layer 42 on a surface of the bottom plate 211, the first base plate 212, and the first cover plate 213.

705. Place the bottom plate 211 and the first cover plate 213 separately over two ends of the first through hole and bond the bottom plate 211 and the first cover plate 213 to the first base plate 212, so that an etching cavity formed by the first through hole 41 is formed in the substrate 21, and the second through hole is connected to the etching cavity and electrically connected to the etching cavity, so as to be used as a waveguide port 23.

The bottom plate 211, the first base plate 212, and the first cover plate 213 whose surfaces are plated with the conducting layer 42 are bonded together, which may achieve metallization of inner and outer surfaces of the substrate 21, thereby implementing electrical connectivity of the surfaces of the substrate 21, so that an electromagnetic wave propagates along a specified path inside the substrate 21.

Assume that there are three waveguide ports and a waveguide port 23 on the right in FIG. 4 needs to be used as an antenna end. When the method illustrated in FIG. 7 is used to prepare the waveguide filter that has three waveguide ports, the first through hole is etched in the first base plate 212, and meanwhile a matching section indicated by a symbol 25 may be formed in the first base plate 212, so that after the bottom plate 211, the first base plate 212, and the first cover plate 213 are bonded, it is ensured that input impedance and output impedance of the waveguide filter match each other.

The first base plate 212 may be a single-layer silicon wafer or a multi-layer stack of silicon wafers, where adjacent silicon wafers among the multiple-layer stack of silicon wafers are bonded together to ensure consistent electrical conductivity between the wafers. The silicon wafer to be used may be a low-resistivity silicon wafer, a high-resistivity silicon wafer, or a relatively-low-purity silicon wafer which have a diameter greater than 2 inches and having a thickness ranging from 100 μm to 2 mm. Because a relatively-low-purity silicon wafer has a low price, use of a relatively-low-purity silicon wafer may reduce a cost for preparing a waveguide filter.

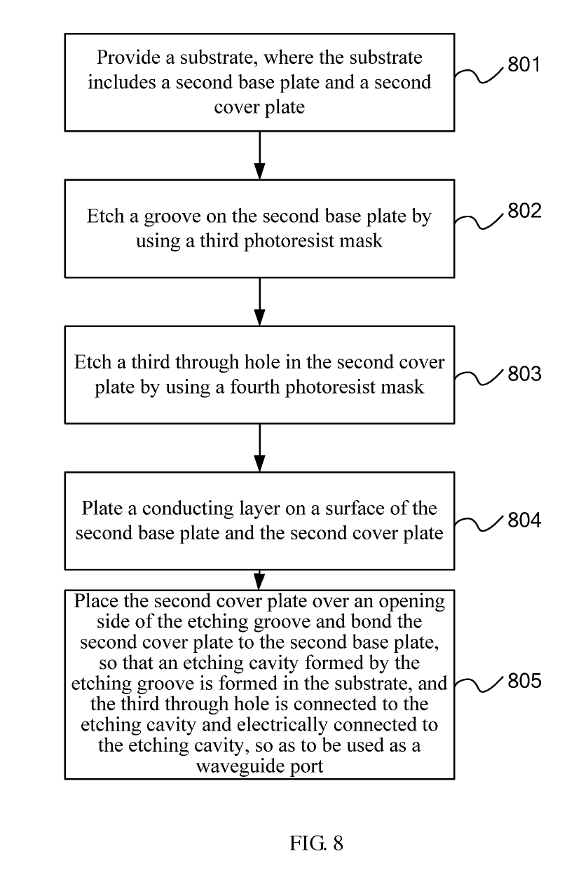

FIG. 8 is a flowchart of a method for preparing another waveguide filter according to an embodiment of the present invention. Referring to FIG. 5 and FIG. 8, the method includes the following steps:

801. Provide a substrate 21, where the substrate 21 includes a second base plate 214 and a second cover plate 215.

802. Etch a groove 51 on the second base plate 214 by using a third photoresist mask.

803. Etch a third through hole in the second cover plate 215 by using a fourth photoresist mask.

804. Plate a conducting layer 52 on a surface of the second base plate 214 and the second cover plate 215.

805. Place the second cover plate 215 over an opening side of the etching groove 51 and bond the second cover plate 215 to the second base plate 214, so that an etching cavity formed by the etching groove 51 is formed in the substrate 21, and the third through hole is connected to the etching cavity and electrically connected to the etching cavity, so as to be used as a waveguide port 23.

The second base plate 214 and the second cover plate 215 whose surfaces are plated with the conducting layer 52 are bonded together, which may achieve metallization of inner and outer surfaces of the substrate 21, thereby implementing electrical connectivity of the surfaces of the substrate 21, so that an electromagnetic wave propagates along a specified path inside the substrate 21.

Assume that there are three waveguide ports and a waveguide port 23 on the right in FIG. 4 needs to be used as an antenna end. When the method illustrated in FIG. 8 is used to prepare the waveguide filter that has three waveguide ports, the groove 51 is etched on the second base plate 214, and meanwhile a matching section indicated by a symbol 25 may be formed on the second base plate 214, so that after the second base plate 214 and the second cover plate 215 are bonded, it is ensured that input impedance and output impedance of the waveguide filter match each other.

The second base plate 214 may be a single-layer silicon wafer or a multi-layer stack of silicon wafers, where adjacent silicon wafers among the multiple-layer stack of silicon wafers are bonded together to ensure consistent electrical conductivity between the wafers. The silicon wafer to be used may be a low-resistivity silicon wafer, a high-resistivity silicon wafer, or a relatively-low-purity silicon wafer which have a diameter greater than 2 inches and having a thickness ranging from 100 μm to 2 mm. Because a relatively-low-purity silicon wafer has a low price, use of a relatively-low-purity silicon wafer may reduce a cost for preparing a waveguide filter.

It should be noted that all the waveguide ports of the waveguide filters illustrated in FIG. 4 and FIG. 5 are disposed on a cover plate; however, the present invention is not limited thereto, and a position of a waveguide port may be designed to be at another position according to an actual need, for example, on a side wall of a base plate. As a structure of the waveguide filters varies, some changes are made to a corresponding preparation method, which is not limited to the foregoing two methods. Steps of any method may be used to implement the present invention as long as a required structure can be prepared by using the MEMS machining process.

In the methods for preparing a waveguide filter according to the foregoing embodiments, a step of plating a conducting layer may be performed by using a magnetron sputtering process or an electroplating process. An objective of plating the conducting layer is to enable inner and outer surfaces of the waveguide filter to be electrical conductive, so that a high-frequency signal can propagate between resonant cavities and can be transmitted, by using the conductive outer surface of the waveguide filter, to another component that is electrically connected to the waveguide filter.

An experiment proves that, by using the methods for preparing a waveguide filter according to the foregoing embodiments, a waveguide filter that is prepared according to pre-designed dimensions (including a length and a height of a resonant cavity, a thickness of a coupling window, an opening width of a coupling window, a length and a width of a waveguide port, a length, a width, and a height of a matching section), has insertion loss smaller than 2.5 decibel (dB) and transceiving suppression greater than 55 dB, when a frequency is greater than 70 GHz. In this way, a radio frequency indicator of the waveguide filter is met.

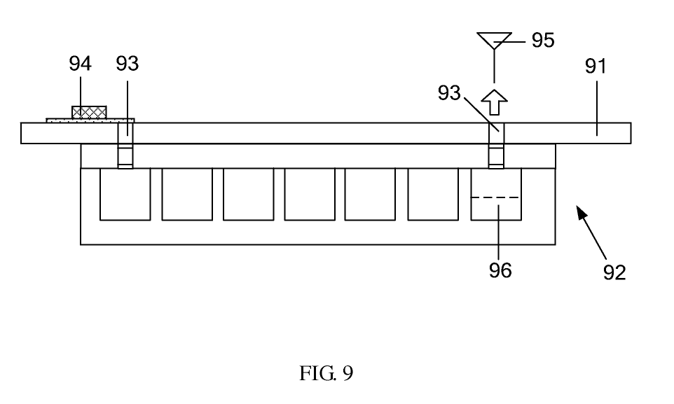

An embodiment of the present invention further provides a communication device. As shown in FIG. 9, the communication device includes a printed circuit board 91, where a waveguide filter 92 described in the foregoing embodiments is mounted on the printed circuit board 91. Because the waveguide filter 92 has a size reduced by 50 times and precision improved by 20 times when compared with a waveguide filter formed by using an existing machining process, an application requirement can be met and debugging may not be required, thereby significantly reducing a manufacturing cost.

A manner for mounting the waveguide filter 92 onto the printed circuit board 91 illustrated in FIG. 9 may be soldering or pressure soldering. In order to ensure that a waveguide port 93 of the waveguide filter 92 is accurately positioned with respect to a corresponding port on the printed circuit board 91, a groove may be etched on the printed circuit board 91 and three or more positioning points (not shown in the figure) may be disposed on the printed circuit board 91. A communication chip 94 which is electrically connected to the waveguide port 93 of the waveguide filter 92 is further mounted on the printed circuit board 91, so as to perform processing on a high-frequency signal obtained from the waveguide port 93, or transmit a processed high-frequency signal to the waveguide filter 92 through the waveguide port 93.

In FIG. 9, a waveguide port 93 below the hollow arrow is an antenna end of the waveguide filter 92, where the hollow arrow indicates that the waveguide port 93 is used to connect an antenna 95. A matching section 96 is disposed inside a corresponding cavity and below the antenna end of the waveguide filter 92, so as to ensure that input impedance and output impedance of the waveguide filter 92 match each other.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A waveguide filter comprising a substrate made of a silicon material and comprising:
an etching cavity having a flat side wall formed in the substrate, wherein a depth of the etching cavity is not greater than 0.7 millimeter (mm), and wherein an angle between the side wall of the etching cavity and a vertical direction is not smaller than 1 degree; and
a waveguide port disposed on the substrate, wherein the waveguide port is connected to the etching cavity and electrically connected to the etching cavity.

2. The waveguide filter according to claim 1, wherein the substrate comprises a bottom plate, a first base plate, and a first cover plate, wherein an etching through hole is disposed in the first base plate, wherein the waveguide port is disposed on the first cover plate, wherein a conducting layer is plated on a surface of the bottom plate, the first base plate, and the first cover plate, and wherein the etching cavity that is connected to the waveguide port and electrically connected to the waveguide port is formed when the bottom plate and the first cover plate are separately placed over two ends of the etching through hole and are bonded to the first base plate.

3. The waveguide filter according to claim 2, wherein the first base plate is a single-layer silicon wafer or a multi-layer stack of silicon wafers, and wherein adjacent silicon wafers among the multiple-layer stack of silicon wafers are bonded together.

4. The waveguide filter according to claim 1, wherein the substrate comprises a second base plate and a second cover plate, wherein an etching groove is disposed on the second base plate, wherein the waveguide port is disposed on the second cover plate, wherein a conducting layer is plated on a surface of the second base plate and the second cover plate, and wherein the etching cavity that is connected to the waveguide port and electrically connected to the waveguide port is formed when the second cover plate is placed over an opening side of the etching groove and is bonded to the second base plate.

5. The waveguide filter according to claim 4, wherein the second base plate is a single-layer silicon wafer or a multi-layer stack of silicon wafers, and wherein adjacent silicon wafers among the multiple-layer stack of silicon wafers are bonded together.

6. The waveguide filter according to claim 2, wherein a material of the conducting layer is a combination of one or more of gold, silver, copper, aluminum, palladium, nickel, titanium, and chromium.

7. The waveguide filter according to claim 2, wherein the conducting layer is a stack of multiple metallic layers.

8. The waveguide filter according to claim 7, wherein an insulation layer is disposed between adjacent metallic layers among the multiple metallic layers.

9. A method for preparing a waveguide filter, comprising:
providing a substrate made of a silicon material;
forming, by using a micro-electro-mechanical systems (MEMS) machining process, an etching cavity in the substrate; and
forming, on the substrate, a waveguide port that is connected to the etching cavity and electrically connected to the etching cavity.

10. The method for preparing a waveguide filter according to claim 9, wherein the substrate comprises a bottom plate, a first base plate, and a first cover plate, and wherein forming the etching cavity and the waveguide port comprises:
etching a first through hole in the first base plate by using a first photoresist mask;
etching a second through hole in the first cover plate by using a second photoresist mask;
plating a conducting layer on a surface of the bottom plate, the first base plate, and the first cover plate; and
placing the bottom plate and the first cover plate separately over two ends of the first through hole and bonding the bottom plate and the first cover plate to the first base plate so that the etching cavity formed by the first through hole is formed in the substrate, wherein the second through hole is connected to the etching cavity and electrically connected to the etching cavity so as to be used as the waveguide port.

11. The method for preparing a waveguide filter according to claim 9, wherein the substrate comprises a second base plate and a second cover plate, and wherein forming the etching cavity and the waveguide port comprises:
etching a groove on the second base plate by using a third photoresist mask;
etching a third through hole in the second cover plate by using a fourth photoresist mask;
plating a conducting layer on a surface of the second base plate and the second cover plate; and
placing the second cover plate over an opening side of the etching groove and bonding the second cover plate to the second base plate so that the etched cavity formed by the etching groove is formed in the substrate, and wherein the third through hole is connected to the etching cavity and electrically connected to the etching cavity so as to be used as the waveguide port.

12. The method for preparing a waveguide filter according to claim 10, wherein plating a conducting layer is performed by using a magnetron sputtering process or an electroplating process.

13. A communication device, comprising a printed circuit board, wherein a waveguide filter is mounted on the printed circuit board, wherein the waveguide filter comprises a substrate made of a silicon material, and wherein the substrate comprises:
an etching cavity having a flat side wall formed in the substrate, wherein a depth of the etching cavity is not greater than 0.7 millimeter (mm), and wherein an angle between the side wall of the etching cavity and a vertical direction is not smaller than 1 degree; and
a waveguide port disposed on the substrate, wherein the waveguide port is connected to the etching cavity and electrically connected to the etching cavity.

14. The communication device according to claim 13, wherein the substrate comprises a bottom plate, a first base plate, and a first cover plate, wherein an etching through hole is disposed in the first base plate, wherein the waveguide port is disposed on the first cover plate, wherein a conducting layer is plated on a surface of the bottom plate, the first base plate, and the first cover plate, and wherein the etching cavity that is connected to the waveguide port and electrically connected to the waveguide port is formed when the bottom plate and the first cover plate are separately placed over two ends of the etching through hole and are bonded to the first base plate.

15. The communication device according to claim 14, wherein the first base plate is a single-layer silicon wafer or a multi-layer stack of silicon wafers, and wherein adjacent silicon wafers among the multiple-layer stack of silicon wafers are bonded together.

16. The communication device according to claim 13, wherein the substrate comprises a second base plate and a second cover plate, wherein an etching groove is disposed on the second base plate, wherein the waveguide port is disposed on the second cover plate, wherein a conducting layer is plated on a surface of the second base plate and the second cover plate, and wherein the etching cavity that is connected to the waveguide port and electrically connected to the waveguide port is formed when the second cover plate is placed over an opening side of the etching groove and is bonded to the second base plate.

17. The communication device according to claim 16, wherein the second base plate is a single-layer silicon wafer or a multi-layer stack of silicon wafers, and wherein adjacent silicon wafers among the multiple-layer stack of silicon wafers are bonded together.

18. The communication device according to claim 14, wherein the conducting layer is a stack of multiple metallic layers, and wherein an insulation layer is disposed between adjacent metallic layers among the multiple metallic layers.

19. The communication device according to claim 13, wherein a manner for mounting the waveguide filter onto the printed circuit board is soldering or pressure soldering.
